(19) United States
(12) Patent Application Publication
(10) Pub. No.: US 2008/0060419 A1
(43) Pub. Date: Mar. 13, 2008

(54) METHOD OF TESTING THE INTEGRITY OF DIALYSIS CIRCUIT FILTERS

(75) Inventors: Milco Albertini, Mirandola (IT); Silvia Cavani, Modena (IT); Domenico Cianciavicchia, Cavuccio (IT); Andrea Fiorenzi, Castelfranco Emilia (IT); Alessandro Pradelli, Finale Emilia (IT); Fabrizio Vaira, Foggia (IT)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Sorin Group Italia S.r.1., Milano (IT)

(21) Appl. No.: 11/850,431

(22) Filed: Sep. 5, 2007

(30) Foreign Application Priority Data
Sep. 5, 2006 (IT) B02006A 000625

(51) Int. Cl. G01M 3/04

(52) U.S. Cl. 73/40.7

(57) ABSTRACT

A method of testing the integrity of a membrane of at least one filter located along a dialysis solution circuit. The method includes the steps of wetting the test membrane with an aqueous solution, expelling the aqueous solution from the filter, filling a fill chamber of the filter with a given quantity of gas after closing the gas flow lines from the fill chamber, and detecting gas flow through the membrane, which bounds the fill chamber.

### CROSS-REFERENCE TO RELATED APPLICATION

This application claims priority under 35 U.S.C. § 119 to Italian Patent Application No. BO2006A 000625 filed Sep. 5, 2006, which is incorporated herein by reference in its entirety.

### TECHNICAL FIELD

The present invention relates to a method of testing the integrity of dialysis circuit filters.

### BACKGROUND

Haemodialysis is a blood-purifying method for restoring hydrosaline balance and eliminating surplus water and toxic substances accumulating in the body as a result of kidney failure, by releasing them to an electrolytic fluid similar to that of normal plasma not containing them. Here and hereinafter, this fluid is referred to as “dialysis solution.” In dialysis, blood drawn from the patient's arm flows along the so-called artery line into the dialyzer, out of the dialyzer along the so-called vein line, and is restored, purified, to the patient.

In haemodiafiltration, to which the following description refers purely by way of example, blood is purified by both diffusion and convection. Purification by diffusion is based on the presence of a concentration gradient between the two solutions on either side of the membrane, which causes solutes to pass to the lower-concentration side; while purification by convection is based on generating in the dialysis fluid a negative hydraulic pressure with respect to the blood. Because the dialysis membrane is partly permeable by solutes, plasma water flow is accompanied by a stream of plasma solutes compatible in size with the porosity of the membrane.

Part of the plasma flow through the membrane is replaced with a sterile substitution fluid, which is added to the extracorporeal blood flow either upstream (pre-dilution) or downstream (post-dilution) from the dialyzer.

The substitution fluid may be formed “on-line” from the dialysis fluid, and, since the dialysis fluid is not always sterile and devoid of pyrogenous substances, is formed by filtering the dialysis fluid using one or two filters located along the dialysis circuit, upstream from the dialyzer, and comprising two chambers separated by a hydrophilic membrane.

### SUMMARY

In one embodiment, the present invention is a method of testing the integrity of a filter in a dialysis solution circuit. The method comprises introducing a gas into a fill chamber of the filter, the fill chamber bound by a membrane, and detecting gas flow from the fill chamber through the membrane.

In another embodiment, the present invention is a method of testing the integrity of a membrane of at least one filter located along a dialysis solution circuit. The filter includes a fill chamber which is bounded by the membrane and is in fluid communication with at least one fluid flow line. The method comprises wetting the membrane with an aqueous solution, expelling the aqueous solution from the filter, blocking the fluid flow line to substantially prevent fluid flow therethrough, introducing a gas into the fill chamber, and detecting gas flow through the membrane.

In yet another embodiment, the present invention is a system for testing a dialysis solution circuit. The system comprises a dialysis filter having a fill chamber bounded by a membrane, means for introducing a gas into the fill chamber, and means for detecting gas flow through the membrane.

### BRIEF DESCRIPTION OF THE DRAWINGS

A number of non-limiting embodiments of the invention will be described by way of example with reference to the accompanying drawings, in which:

FIG. 1 is a schematic view of a portion of a dialysis machine in accordance with a first embodiment of the present invention;

FIG. 2 is a schematic view of a portion of a dialysis machine in accordance with a second embodiment of the present invention; and

FIG. 3 is a schematic view of a portion of a dialysis machine in accordance with a third embodiment of the present invention.

### DETAILED DESCRIPTION

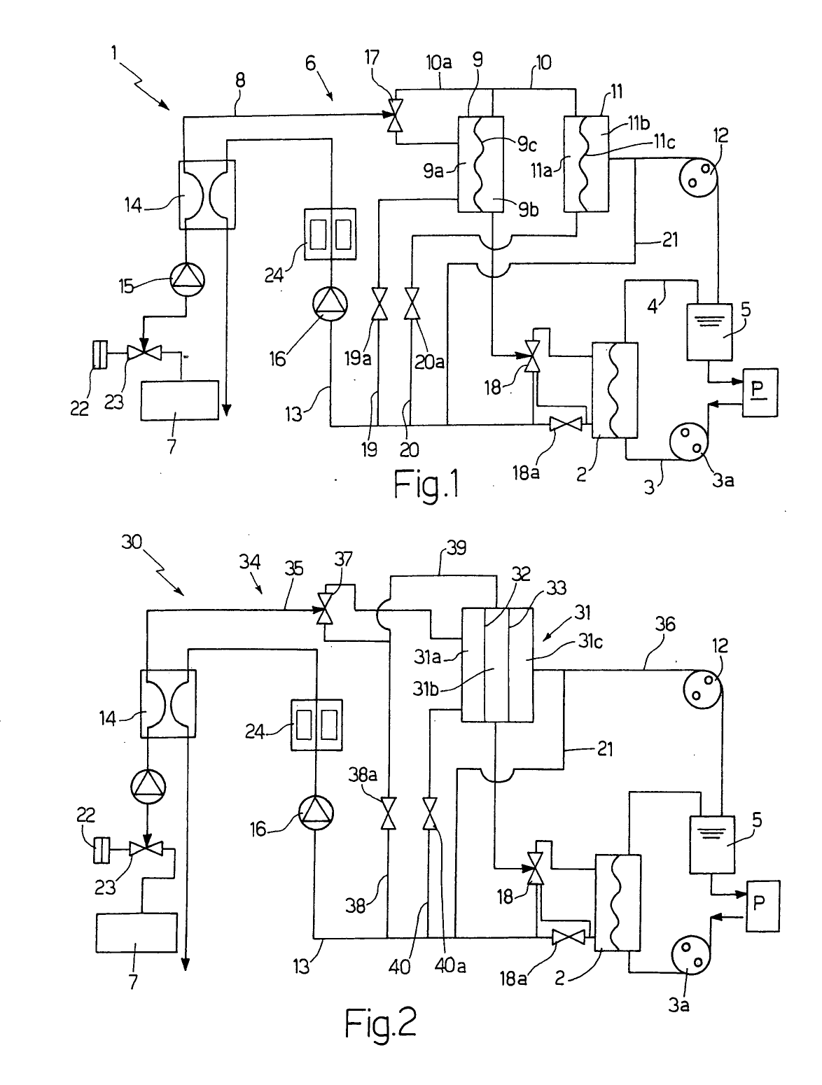

FIG. 1 is a schematic view of portions of a dialysis machine 1 in accordance with one embodiment of the present invention. As shown in FIG. 1, the dialysis machine 1 comprises a known haemodialysis filter 2 (not described in detail), an artery line 3 for feeding blood from a patient P to filter 2, a pump 3a fitted to artery line 3 to ensure blood flow, a vein line 4 for feeding blood from filter 2 to patient P, a drip chamber 5 located along vein line 4, and a dialysis solution circuit 6.

In the illustrated embodiment, the dialysis solution circuit 6 comprises a preparation device 7, an inflow branch 8 for feeding dialysis solution to filter 2, a first sterile filter 9 along inflow branch 8, a substitution-fluid line 10 for feeding substitution fluid from first sterile filter 9 to drip chamber 5, a second sterile filter 11 along substitution-fluid line 10, a pump 12 located along substitution-fluid line 10, downstream from second sterile filter 11, a dialysis solution outflow branch 13 from filter 2, and a flow gauge 14 through which inflow branch 8 and outflow branch 13 extend. Inflow branch 8 and outflow branch 13 are fitted with respective pumps 15 and 16.

As shown, the first and second sterile filters 9, 11 each comprise a pair of chambers 9a, 9b and 11a, 11b, with each pair separated by a hydrophilic membrane 9c, 11c, respectively. In various embodiments, the membranes 9c, 11c are configured to prevent bacteria or endotoxins in the dialysis solution from passing from the chambers 9a, 11a to the chambers 9b, 11b, respectively, of the filters 9, 11.

Inflow branch 8 comprises a first bypass solenoid valve 17 for bypassing the chamber 9a of first sterile filter 9 and connecting inflow branch 8, by means of a connecting line 10a, to chamber 9b of the first sterile filter and, hence, to substitution-fluid line 10, which, in the example shown, extends from chamber 9b of filter 9. Inflow branch 8 also comprises a second bypass solenoid valve 18 for bypassing haemodialysis filter 2 and connecting inflow branch 8 directly to outflow branch 13, either upstream or downstream from a solenoid valve 18a, depending on the operating mode employed.

Dialysis machine 1 comprises a first drain line 19 connecting chamber 9a of first sterile filter 9 to outflow branch 13, and a second drain line 20 connecting chamber 11a of second sterile filter 11 to outlet branch 13. Drain lines 19, 20 are fitted with respective solenoid spill valves 19a, 20a, which are opened periodically to wash the membranes of filters 9 and 11 and prevent accumulated bacteria and endotoxins from impairing operation of the filters.

Dialysis machine 1 also comprises a test line 21 connecting substitution-fluid line 10, downstream from second sterile filter 11, to outflow branch 13.

Finally, in the illustrated embodiment, the dialysis machine 1 comprises an antibacterial filter 22 for filtering outside air, a solenoid valve 23 for switching the fluid source of inflow branch 8 from preparation device 7 to antibacterial filter 22, and an air sensor 24 located along outflow branch 13, downstream from the connections to drain lines 19, 20 and test line 21. The sensor 24 can be of any type suitable for detecting fluid flow through the outflow branch 13. In one embodiment, the sensor 24 may be an ultrasound sensor. In one embodiment, the sensor 24 may be an optical sensor. In various embodiments, the sensor 24 may be a continuous-reading type sensor. In other embodiments, other types of sensors may be utilized.

In actual use, once dialysis treatment is completed, the dialysis machine 1 is switched from dialysis mode to wash/test mode. After dialysis solution circuit 6 has been flushed with an aqueous solution, e.g. the dialysis solution itself, solenoid valve 23 is switched to antibacterial filter 22 to feed circuit 6 with air from antibacterial filter 22 as opposed to the dialysis solution from preparation device 7. At the same time, the outlet of chamber 9b of first filter 9 is closed by closing solenoid valve 18a and switching bypass solenoid valve 18 to the circuit portion upstream from solenoid valve 18a, the outlet of chamber 11a of second filter 11 is closed by closing solenoid valve 20a. In addition, the solenoid valve 17 is set to connect inflow branch 8 directly to substitution-fluid line 10, so that the air pumped by pump 15 is fed into chamber 9b of first sterile filter 9 and into chamber 11a of second sterile filter 11 to expel the liquid from the filters. In the event of damage to either one of membranes 9c, 11c separating chambers 9a and 9b and chambers 11a and 11b respectively, air flows along drain line 19 or test line 21, and is detected by sensor 24. More specifically, comparison of the information from sensor 24 with a reference threshold determines the integrity or not of membranes 9c and 11c and, hence, of filters 9 and 11.

Moreover, by acting on solenoid valve 19a, the integrity first of membrane 11c and then of membrane 9c can be tested separately.

FIG. 2 is a schematic view of portions of a dialysis machine 30 according to another embodiment of the present invention. Parts identical to those of dialysis machine 1 are indicated using the same reference numbers, with no further description. As can be seen in FIG. 2, the dialysis machine 30 differs from dialysis machine 1 by comprising one three-chamber filter 31 as opposed to two sterile filters 9 and 11 (see FIG. 1), which means integrity testing of machine 30 applies to filter 31 and, more specifically, to the two membranes 32 and 33 dividing filter 31 into three chambers 31a, 31b, 31c.

As shown, dialysis machine 30 comprises a dialysis solution circuit 34 connected selectively to chamber 31a or chamber 31b of filter 31, and a substitution-fluid line 36 connecting chamber 31c of filter 31 to drip chamber 5.

In the illustrated embodiment, the inflow branch 35 comprises a bypass solenoid valve 37 which, in test mode, bypasses chamber 31a of filter 31 to connect inflow branch 35 directly, along a connecting line 39, to chamber 31b. In normal operating mode, solenoid valve 37 connects inflow branch 35 to chamber 31a of filter 31, spill valve 38a.

As further shown, the dialysis machine 30 also comprises a drain line 40 connecting chamber 31a directly to outflow branch 13, and which is fitted with a solenoid spill valve 40a.

In actual use, once dialysis treatment is completed, dialysis machine 30 is switched from dialysis mode to wash/test mode. After dialysis solution circuit 34 has been flushed with an aqueous solution, e.g. the dialysis solution itself, solenoid valve 23 is switched to antibacterial filter 22 to feed circuit 34 with air from antibacterial filter 22 as opposed to the dialysis solution from preparation device 7.

At the same time, the outlet of chamber 31b of filter 31 is closed by closing solenoid valve 18a and switching bypass solenoid valve 18 to the circuit portion upstream from solenoid valve 18a, and solenoid valve 37 is set to connect inflow branch 35 directly to chamber 31b of filter 31, so that the air pumped by pump 15 is fed into chamber 31b of filter 31 to expel the liquid from the filter. In the event of damage to either one of membranes 32, 33, air flows along drain line 40 or test line 21, and is detected by sensor 24. As in dialysis machine 1, comparison of the information from sensor 24 with a reference threshold determines the integrity or not of membranes 32 and 33 and, hence, of filter 31.

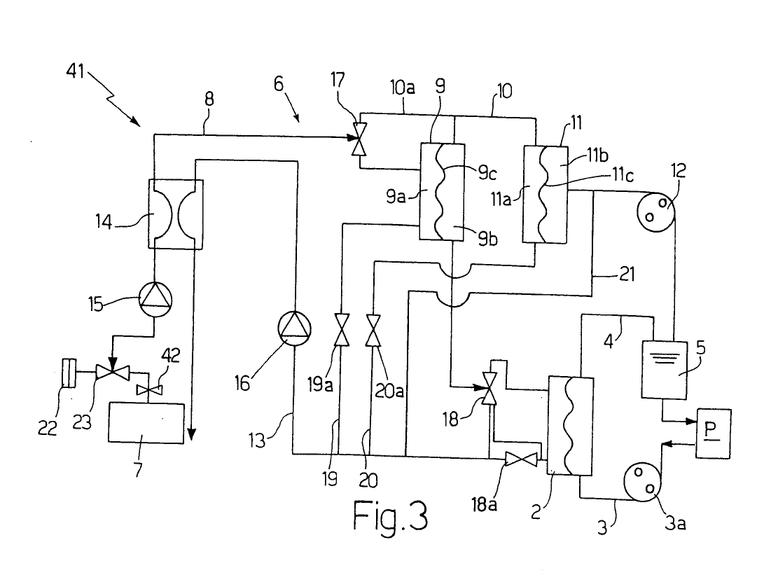

FIG. 3 is a schematic view of portions of a dialysis machine 41 according to a third embodiment of the present invention. Parts identical to those of dialysis machine 1 are indicated using the same reference numbers, with no further description. As can be seen in FIG. 3, the dialysis machine 41 differs from dialysis machine 1 by having no sensor 24, and by comprising a solenoid valve 42 located between preparation device 7 and solenoid valve 23 to completely cut off inflow branch 8 when solenoid valve 23 is switched to preparation device 7.

In actual use, once dialysis treatment is completed, dialysis machine 41 is switched from dialysis mode to wash/test mode. After dialysis solution circuit 6 has been flushed with an aqueous solution, e.g. the dialysis solution itself, solenoid valve 23 is switched to antibacterial filter 22 to feed air into respective chambers 9b and 11a of filters 9 and 11, in the same way as described for machine 1. Once chamber 9b of filter 9 and chamber 11a of filter 11 are filled with air, solenoid valve 23 is switched to preparation device 7, and branch 8 is fed with a sufficient amount of fluid to further compress the air inside chambers 9b and 11a.

At this point, solenoid valve 42 is closed, and flow along branch 8 is measured by differential flow gauge 14. In other words, any damage to either one of membranes 9c, 11c would result in air flow and, consequently, flow of the fluid compressing the air, thus giving a flow reading of other than zero along branch 8.

As will be apparent to anyone skilled in the art, the test method and relative unit according to the present invention are controlled by a known central control unit not described or illustrated.

We claim:

1. A method of testing the integrity of a membrane of at least one filter located along a dialysis solution circuit, the filter including a fill chamber bounded by the membrane and in fluid communication with at least one fluid flow line, the method comprising:
wetting the membrane with an aqueous solution;
expelling the aqueous solution from the filter;
blocking the fluid flow line to substantially prevent fluid flow therethrough;
introducing a gas into the fill chamber; and
detecting gas flow through the membrane.

2. The method of claim 1 wherein expelling the aqueous solution from the filter is performed by filling the fill chamber with the gas.

3. The method of claim 1 wherein the gas is air filtered by an antibacterial filter.

4. The method of claim 1 wherein detecting gas flow includes indirectly detecting gas flow by first compressing the gas in the fill chamber using a second fluid, and subsequently detecting a flow of the second fluid.

5. The method of claim 4 wherein the detecting the flow of the second fluid is performed using a differential flow gauge.

6. The method of claim 1 wherein the filter includes a second chamber separated from the fill chamber by the membrane, and wherein the dialysis solution circuit further includes a second fluid flow line in fluid communication with the second chamber, and wherein detecting gas flow is performed using a sensor located along the second fluid flow line.

7. A method of testing the integrity of a filter in a dialysis solution circuit, the method comprising introducing a gas into a fill chamber of the filter, the fill chamber being bound by a membrane, and detecting gas flow from the fill chamber through the membrane.

8. A system for testing a dialysis solution circuit, the system comprising:
a dialysis filter having a fill chamber bounded by a membrane;
means for introducing a gas into the fill chamber; and
means for detecting gas flow through the membrane.

9. The system of claim 8 further comprising:
a gas flow line in fluid communication with the fill chamber; and
a valve in the gas flow line configured to substantially prevent gas flow out of the fill chamber through the gas flow line.

10. The system of claim 8 wherein the means for introducing a gas includes:
an antibacterial filter;
a first valve connecting the antibacterial filter to the dialysis solution circuit; and
a pump in the dialysis solution circuit.

11. The system of claim 10 further comprising:
a preparation device configured to supply fluid to the dialysis solution circuit; and
a second valve located between the first valve and the preparation device.

12. The system of claim 11 wherein the means for detecting gas flow is a differential flow gauge.

13. The system of claim 8 wherein the filter includes a second chamber separated from the fill chamber by the membrane, and the means for detecting gas flow includes a sensor configured to sense gas flow from the second chamber.

14. The system of claim 13 wherein the filter includes a third chamber separated by the fill chamber by a second membrane, and wherein the sensor is further configured to sense gas flow from the third chamber.
